(19) United States
(12) Patent Application Publication
(10) Pub. No.: US 2004/0117222 A1
(43) Pub. Date: Jun. 17, 2004

(54) System and method for evaluating information aggregates by generation of knowledge capital

(75) Inventors: Vaughn T. Rokosz, Newton, MA (US); Andrew L. Schirmer, Andover, MA (US); Marijane M. Zeller, Medford, MA (US)

Correspondence Address: Shelley M. Beckstrand, 314 Main Street, Owego, NY, 13827-1616, US

(73) Assignee: International Business Machines Corporation, Armonk, NY

(21) Appl. No.: 10/319,171

(22) Filed: Dec. 14, 2002

(51) Int. Cl. G06F 17/60

(52) U.S. Cl. 705/7

(57) ABSTRACT

Information in a database collection of knowledge resources is evaluated by collecting a plurality of documents having non-unique values on a shared attribute into an information aggregate; assigning to each document an usefulness value; and calculating and visualizing the knowledge capital of the aggregate as a sum of the usefulness values for all documents in the aggregate.

### CROSS REFERENCES TO RELATED APPLICATIONS

The following copending U.S. patent application is assigned to the same assignee hereof and contains subject matter related, in certain respect, to the subject matter of the present application. This patent application is incorporated herein by reference.

Ser. No. ______, filed ______ for “SYSTEM AND METHOD FOR FINDING THE ACCELERATION OF AN INFORMATION AGGREGATE”, assignee docket LOT920020008US1;

### BACKGROUND OF THE INVENTION

1. Technical Field of the Invention

This invention relates to a method and system for evaluating information aggregates. More particularly, it relates to identifying and visualizing knowledge capital generated within such aggregates.

2. Background Art

Corporations are flooded with information. The Web is a huge and sometimes confusing source of external information which only adds to the body of information generated internally by a corporation's collaborative infrastructure, including E-mail, Notes databases, QuickPlaces, and so on. With so much information available, it is difficult to determine what's important and what's worth looking at.

Collaborative applications such as Lotus Notes or Microsoft Exchange provide an easy way for people to create and share documents. But it can be difficult in these systems to understand whether documents are valuable. Documents that are valuable represent one form of the knowledge capital of a corporation, and they can be useful to understand where knowledge capital originates. If, for example, one could identify a geography responsible for generating a great deal of knowledge capital, it might be possible to determine if that geography has adopted local practices that are particularly effective. Such practices could then be promulgated to other geographies for their benefit.

There are systems that attempt to identify important documents, but these systems are focused on individual documents and not on aggregates of documents. For example, search engines look for documents based on specified keywords, and rank the results based on how well the search keywords match the target documents. Each individual document is ranked, but collections of documents are not analyzed.

Systems that support collaborative filtering provide a way to assign a value to documents based on user activity, and can then find similar documents. For example, Amazon.com can suggest books to a patron by looking at the books the patron has purchased in the past. The patron can rate these purchases to help the system determine the value of those books to him, and Amazon can then find similar books (based on the purchasing patterns of other people). One such collaborative filtering system does not aggregate documents into collections, and does not calculate a value for document collections. Users are responsible for manually entering a rating, rather than have the rating be derived from usage.

Another system and method for knowledge management provides for determining document value based on usage. However, the documents are aggregated, and the primary use of the document value is in the ranking of search results.

The Lotus Discovery Server (LDS) is a Knowledge Management (KM) tool that allows users to more rapidly locate the people and information they need to answer their questions. It categorizes information from many different sources (referred to generally as knowledge repositories) and provides a coherent entry point for a user seeking information. Moreover, as users interact with LDS and the knowledge repositories that it manages, LDS can learn what the users of the system consider important by observing how users interact with knowledge resources. Thus, it becomes easier for users to quickly locate relevant information.

The focus of LDS is to provide specific knowledge or answers to localized inquiries; focusing users on the documents, categories, and people who can answer their questions. There is a need, however, to magnify existing trends within the system—thus focusing on the system as a whole instead of specific knowledge.

It is an object of the invention to provide an improved system and method for determining and visualizing knowledge capital generated within a knowledge repository.

### SUMMARY OF THE INVENTION

System and method for evaluating information aggregates by collecting a plurality of documents having non-unique values on a shared attribute into an information aggregate; assigning to each document an usefulness value; and calculating and visualizing a knowledge capital of the aggregate as a sum of the usefulness values for all documents in the aggregate.

In accordance with an aspect of the invention, there is provided a computer program product configured to be operable for evaluating information aggregates knowledge capital generated within information aggregates.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a diagrammatic representation of visualization portfolio strategically partitioned into four distinct domains in accordance with the preferred embodiment of the invention.

FIG. 2 is a system diagram illustrating a client/server system in accordance with the preferred embodiment of the invention.

FIG. 3 is a system diagram further describing the web application server of FIG. 2.

FIG. 4 is a diagrammatic representation of the XML format for wrapping SQL queries.

FIG. 5 is a diagrammatic representation of a normalized XML format, or QRML.

FIG. 6 is a diagrammatic representation of an aggregate in accordance with the preferred embodiment of the invention.

FIG. 7 is a diagrammatic representation of knowledge capital for a set of categories.

FIG. 8 is a diagrammatic representation normalized knowledge capital for a set of communities showing trends over time.

FIG. 9 is a flow chart representation of a preferred embodiment of the invention for visualizing community and category knowledge capital.

### DETAILED DESCRIPTION OF PREFERRED EMBODIMENTS

In accordance with the present invention, a system and method is provided for determining the amount of knowledge capital generated by various sources, including people, locations, communities, and so forth. The knowledge capital measure of the present invention focuses on collections of documents, rather than individual documents. It provides a way to view knowledge capital generated by different sources, since document collections can be formed in a variety of different ways.

Sources of knowledge capital are determined by aggregating documents into collections based on document meta-data, and the knowledge capital value is assigned based on usage metrics associated with documents in a community, category, job role, person or other such collection of documents.

In accordance with the preferred embodiment of the invention, knowledge capital is assessed based on usefulness values assoicated with information aggregates within the context of a Lotus Discovery Server (LDS). The Lotus Discovery Server is a system that supports the collection of documents into information aggregates. The aggregates supported by LDS, and for which knowledge capital is determined, include categories and communities.

The Lotus Discovery Server (LDS) is a Knowledge Management (KM) tool that allows users to more rapidly locate the people and information they need to answer their questions. In an exemplary embodiment of the present invention, the functionality of the Lotus Discovery Server (LDS) is extended to include useful visualizations that magnify existing trends of an aggregate system. Useful visualizations of knowledge metric data store by LDS are determined, extracted, and visualized for a user.

On its lowest level, LDS manages knowledge resources. A knowledge resources is any form of document that contains knowledge or information. Examples include Lotus WordPro Documents, Microsoft Word Documents, webpages, postings to newsgroups, etc. Knowledge resources are typically stored within knowledge repositories—such as Domino.Doc databases, websites, newsgroups, etc.

When LDS is first installed, an Automated Taxonomy Generator (ATG) subcomponent builds a hierarchy of the knowledge resources stored in the knowledge repositories specified by the user. For instance, a document about working with XML documents in the Java programming language stored in a Domino.Doc database might be grouped into a category named ‘Home>Development>Java>XML’. This categorization will not move or modify the document, just record its location in the hierarchy. The hierarchy can be manually adjusted and tweaked as needed once initially created.

A category is a collection of knowledge resources and other subcategories of similar content, generically referred to as documents, that are concerned with the same topic. A category may be organized hierarchically. Categories represent a more abstract re-organization of the contents of physical repositories, without displacing the available knowledge resources. For instance, in the following hierarchy:

Home (Root of the hierarchy)

Animals

Dogs

Cats

Industry News and Analysis

CNN

ABC News

MSNBC

‘Home>Animals’, ‘Home>Industry News and Analysis’, and ‘Home>Industry News and Analysis>CNN’ are each categories that can contain knowledge resources and other subcategories. Furthermore, ‘Home>Industry News and Analysis>CNN’ might contain documents from www.cnn.com and documents created by users about CNN articles which are themselves stored in a Domino.Doc database.

A community is a collection of documents that are of interest to a particular group of people collected in an information repository. The Lotus Discovery Server (LDS) allows a community to be defined based on the information repositories used by the community. Communities are defined by administrative users of the system (unlike categories which can be created by LDS and then modified). If a user interacts with one of the repositories used to define Community A, then he is considered an active participant in that community. Thus, communities provide a mechanism for LDS to observe the activity of a group of people.

LDS maintains a score, or document value, for a knowledge resource (document) which is utilized to indicate how important it is to the users of the system. For instance, a document that has a lot of usage, or activity around it—such as reading the document, responding to the document, editing the document, or referencing the document from a different document—is perceived as more important than documents which are rarely accessed.

The system and method of the preferred embodiments of the invention are built on a framework that collectively integrates data-mining, user-interface, visualization, and server-side technologies. An extensible architecture provides a layered process of transforming data sources into a state that can be interpreted and outputted by visualization components. This architecture is implemented through Java, Servlets, JSP, SQL, XML, and XSLT technology, and essentially adheres to a model-view controller paradigm, where interface and implementation components are separated. This allows effective data management and server side matters such as connection pooling to be independent

In accordance with the preferred embodiment of the invention, information visualization techniques are implemented through the three main elements including bar charts, pie charts, and tables. Given the simplicity of the visualization types themselves, the context in which they are contained and rendered is what makes them powerful mediums to reveal and magnify hidden knowledge dynamics within an organization.

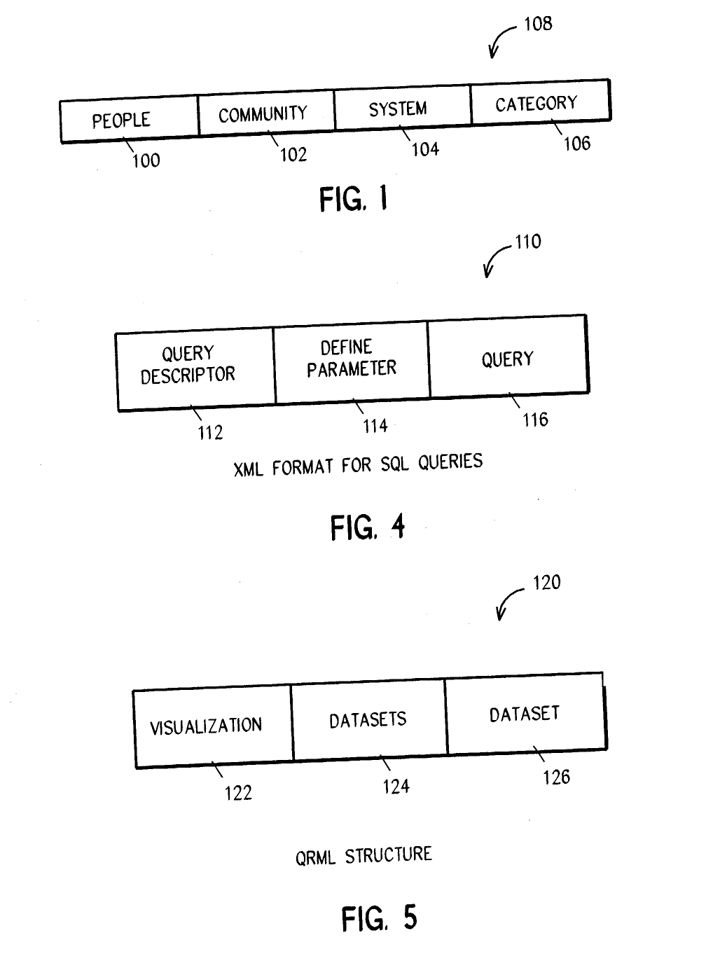

Referring to FIG. 1, a visualization portfolio is strategically partitioned into four distinct domains, or explorers: people 100, community 102, system 104, and category 106. The purpose of these partitioned explorers 100-106 is to provide meaningful context for the visualizations. The raw usage pattern metrics produced from the Lotus Discovery Server (LDS) do not raise any significant value unless there is an applied context to it. In order to shed light on the hidden relationships behind the process of knowledge creation and maintenance, there is a need to ask many important questions. Who are the knowledge creators? Who are the ones receiving knowledge? What group of people are targeted as field experts? How are groups communicating with each other? Which categories of information are thriving or lacking activity? How is knowledge transforming through time? While answering many of these questions, four key targeted domains, or explorer types 100-106 are identified, and form the navigational strategy for user interface 108. This way, users can infer meaningful knowledge trends and dynamics that are context specific.

### People Domain 100

People explorer 100 focuses on social networking, community connection analysis, category leaders, and affinity analysis. The primary visualization component is table listings and associations.

### Community Domain 102

Community explorer 102 focuses on acceleration, associations, affinity analysis, and document analysis for communities. The primary visualization components are bar charts and table listings. Features include drill down options to view associated categories, top documents, and top contributors.

Communities group users by similar interests. Metrics that relate to communities help to quickly gauge the activities of a group of people with similar interests. Essentially, these metrics help gauge the group of people, whereas the category visualizations help to gauge knowledge trends.

### System Overview

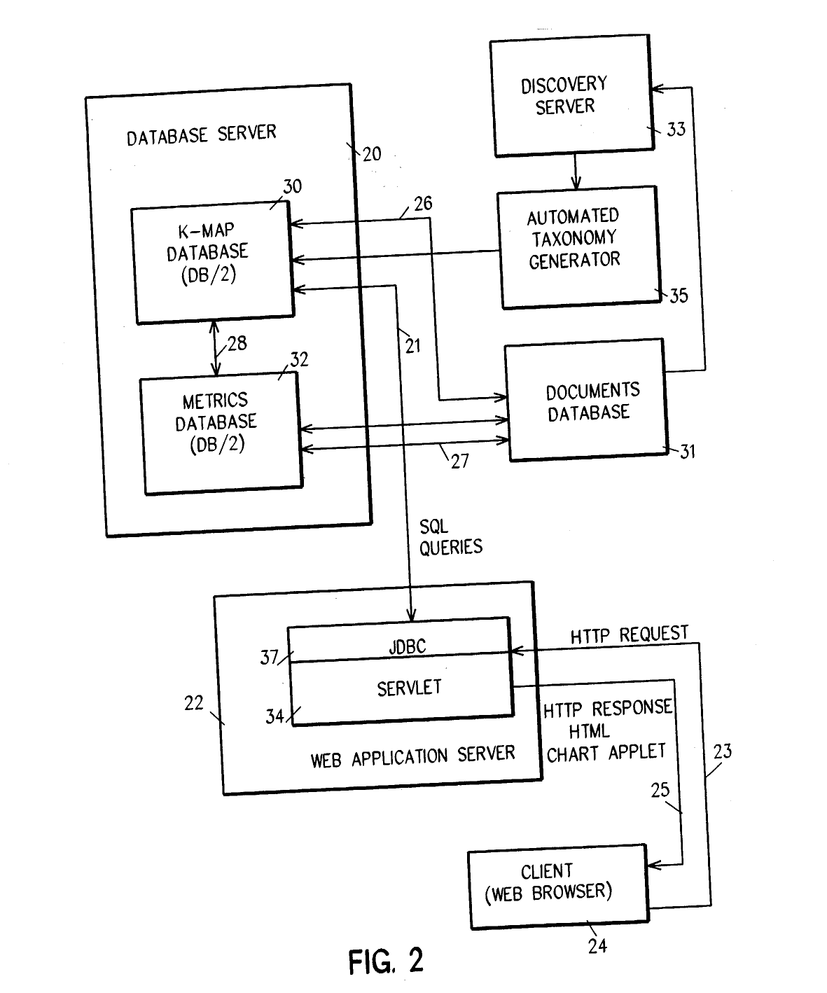

Referring to FIG. 2, an exemplary client/server system is illustrated, including database server 20, discovery server 33, automated taxonomy generator 35, web application server 22, and client browser 24.

Knowledge management is defined as a discipline to systematically leverage information and expertise to improve organizational responsiveness, innovation, competency, and efficiency. Discovery server 33 (e.g. Lotus Discovery Server) is a knowledge system which may deployed across one or more servers. Discovery server 33 integrates code from several sources (e.g., Domino, DB2, InXight, KeyView and Sametime) to collect, analyze and identify relationships between documents, people, and topics across an organization. Discovery server 33 may store this information in a data store 31 and may present the information for browse/query through a web interface referred to as a knowledge map (e.g., K-map) 30. Discovery server 33 regularly updates knowledge map 30 by tracking data content, user expertise, and user activity which it gathers from various sources (e.g. Lotus Notes databases, web sites, file systems, etc.) using spiders.

Database server 20 includes knowledge map database 30 for storing a hierarchy or directory structure which is generated by automated taxonomy generator 35, and metrics database 32 for storing a collection of attributes of documents stored in documents database 31 which are useful for forming visualizations of information aggregates. The k-map database 30, the documents database 31, and the metrics database are directly linked by a key structure represented by lines 26, 27 and 28. A taxonomy is a generic term used to describe a classification scheme, or a way to organize and present information, Knowledge map 30 is a taxonomy, which is a hierarchical representation of content organized by a suitable builder process (e.g., generator 35).

A spider is a process used by discovery server 33 to extract information from data repositories. A data repository (e.g. database 31) is defined as any source of information that can be spidered by a discovery server 33.

Java Database Connectivity API (JDBC) 37 is used by servlet 34 to issue Structured Query Language (SQL) queries against databases 30, 31, 32 to extract data that is relevant to a users request 23 as specified in a request parameter which is used to filter data. Documents database 31 is a storage of documents in, for example, a Domino database or DB2 relational database.

The automated taxonomy generator (ATG) 35 is a program that implements an expectation maximization algorithm to construct a hierarchy of documents in knowledge map (K-map) metrics database 32, and receives SQL queries on link 21 from web application server 22, which includes servlet 34. Servlet 34 receives HTTP requests on line 23 from client 24, queries database server 20 on line 21, and provides HTTP responses, HTML and chart applets back to client 24 on line 25.

Discovery server 33, database server 20 and related components are further described in U.S. patent application Ser. No. 10,044,914 filed Jan. 15, 2002 for System and Method for Implementing a Metrics Engine for Tracking Relationships Over Time.

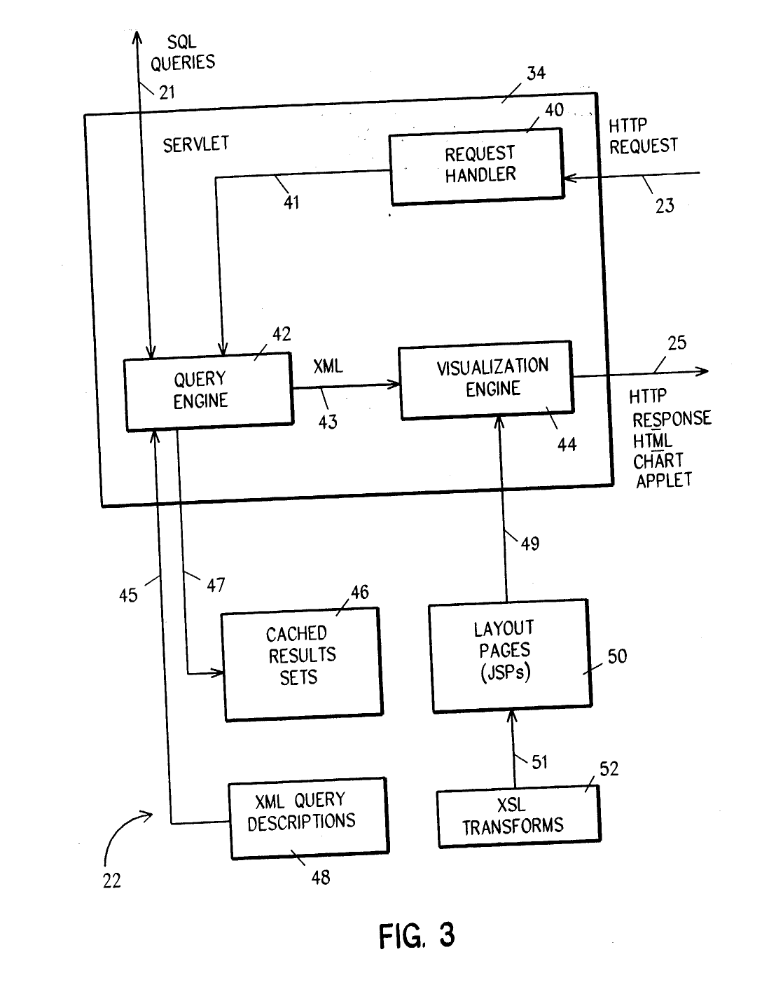

Referring to FIG. 3, web application server 22 is further described. Servlet 34 includes request handler 40 for receiving HTTP requests on line 23, query engine 42 for generating SQL queries on line 21 to database server 20 and result set XML responses on line 43 to visualization engine 44. Visualization engine 44, selectively responsive to XML 43 and layout pages (JSPs) 50 on line 49, provides on line 25 HTTP responses, HTML, and chart applets back to client 24. Query engine 42 receives XML query descriptions 48 on line 45 and caches and accesses results sets 46 via line 47. Layout pages 50 reference XSL transforms 52 over line 51.

In accordance with the preferred embodiment of the invention, visualizations are constructed from data sources 32 that contain the metrics produced by a Lotus Discovery Server. The data source 32, which may be stored in an IBM DB2 database, is extracted through tightly coupled Java and XML processing.

Referring to FIG. 4, the SQL queries 21 that are responsible for extraction and data-mining are wrapped in a result set XML format having a schema (or structure) 110 that provides three main tag elements defining how the SQL queries are executed. These tag elements are <queryDescriptor> 112, <defineparameter> 114, and <query> 116.

The <queryDescriptor> element 112 represents the root of the XML document and provides an alias attribute to describe the context of the query. This <queryDescriptor> element 112 is derived from http request 23 by request handlekr 40 and fed to query engine 42 as is represented by line 41.

The <defineparameter> element 114 defines the necessary parameters needed to construct dynamic SQL queries 21 to perform conditional logic on metrics database 32. The parameters are set through its attributes (localname, requestParameter, and defaultValue). The actual parameter to be looked up is requestParameter. The localname represents the local alias that refers to the value of requestParameter. The defaultValue is the default parameter value.

QRML structure 116 includes <query> element 116 containing the query definition. There can be one or more <query> elements 116 depending on the need for multiple query executions. A<data> child node element is used to wrap the actual query through its corresponding child nodes. The three essential child nodes of <data> are <queryComponent>, <useParameter>, and <queryAsFullyQualified>. The <queryComponent> element wraps the main segment of the SQL query. The <useParameter> element allows parameters to be plugged into the query as described in <defineParameter>. The <queryAsFullyQualified> element is used in the case where the SQL query 21 needs to return an unfiltered set of data.

Table 1 provides an example of this XML structure 110.

TABLE 1
XML STRUCTURE EXAMPLE

| | |
|---|---|
| 3 | <?xml version=“1.0” encoding=“UTF-8” ?> |
| 4 | <queryDescriptor alias=“AffinityPerCategory” > |
| 5 | <defineParameter |
| 6 | localname=“whichCategory” |
| 7 | requestParameter=“category” |
| 8 | defaultValue=“Home” |
| 9 | /> |
| 10 | <query> |
| 11 | <data> |
| 12 | <queryComponent |
| 13 | value=“select cast(E.entityname as varchar(50)), |
| 14 | cast(substr(E.entityname, length(’” |
| 15 | /> |
| 16 | <useParameter |
| 17 | value=“whichCategory” /> |
| 18 | <queryComponent |
| 19 | value=“>‘)+1, length(E.entityname)-length(’” |
| 20 | /> |
| 21 | <useParameter |
| 22 | value=“whichCategory” /> |
| 23 | <queryComponent |
| 24 | value=“>‘)+1) as varchar(50)) , decimal((select |
| 25 | sum(M.value) from lotusrds.metrics M, lotusrds.registry R, |
| 26 | lotusrds.entity E2 where M.metricid = R.metricid and |
| 27 | R.metricname = ‘AFFINITY’ and M.value > 0 and E2.entityid = |
| 28 | M.entityid1 and substr(E2.entityname,1, |
| 29 | length(E.entityname)) = cast(E.entityname as |
| 30 | varchar(50))),8,4) as aff_sum from lotusrds.entity E where |
| 31 | E.entityname in (select E3.entityname from lotusrds.entity |
| 32 | E3 where E3.entityname like ’” |
| 33 | /> |
| 34 | <useParameter |
| 35 | value=“whichCategory” /> |
| 36 | <queryComponent |
| 37 | value=“>%’ ” |
| 38 | /> |
| 39 | <queryAsFullyQualified |
| 40 | parameter=“whichCategory” |
| 41 | prefix=“and E3.entityname not like ’” |
| 42 | suffix=“>%>%’” /> |
| 43 | <queryComponent |
| 44 | value=“) order by aff_sum DESC, E.entityname” |
| 45 | /> |
| 46 | </data> |
| 47 | </query> |
| 48 | </queryDescriptor> |

When a user at client browser 24 selects a metric to visualize, the name of an XML document is passed as a parameter in HTTP request 23 to servlet 34 as follows:

<input type=hidden name=“queryAlias” value=“AffinityPerCategory”>

In some cases, there is a need to utilize another method for extracting data from the data source 32 through the use of a generator Java bean. The name of this generator bean is passed as a parameter in HTTP request 23 to servlet 34 as follows:

<input type=hidden name=“queryAlias”value=“PeopleInCommonByCommGenerator”>

Once servlet 34 receives the XML document name or the appropriate generator bean reference at request handler 40, query engine 42 filters, processes, and executes query 21. Once query 21 is executed, data returned from metrics database 32 on line 21 is normalized by query engine 42 into an XML format 43 that can be intelligently processed by a stylesheet 52 further on in the process.

Referring to FIG. 5, the response back to web application server 22 placed on line 21 is classified as a Query Response Markup Language (QRML) 120. QRML 120 is composed of three main elements. They are <visualization> 122, <datasets> 124, and <dataset> 126. QRML structure 120 describes XML query descriptions 48 and the construction of a result set XML on line 43.

The <visualization> element 122 represents the root of the XML document 43 and provides an alias attribute to describe the tool used for visualization, such as a chart applet, for response 25.

The <datasets> element 124 wraps one or more <dataset> collections depending on whether multiple query executions are used.

The <dataset> element 126 is composed of a child node <member> that contains an attribute to index each row of returned data. To wrap the raw data itself, the <member> element has a child node <elem> to correspond to column data.

Table 2 illustrates an example of this normalized XML, or QRML, structure.

TABLE 2
NORMALIZED XML STRUCTURE EXAMPLE (QRML)

| | |
|---|---|
| 6 | <visualization> |
| 7 | <datasets> |
| 8 | <dataset> |
| 9 | <member index=“1”> |
| 10 | <elem>25</elem> |
| 11 | <elem>36</elem> |
| 12 | .... |
| 13 | </member> |
| 14 | <member index=“2”> |
| 15 | <elem>26</elem> |
| 16 | <elem>47</elem> |
| 17 | .... |
| 18 | </member> |
| 19 | .... |
| 20 | </dataset> |
| 21 | </datasets> |
| 22 | </visualization> |

### Data Translation and Visualization

Referring further to FIG. 3, for data translation and visualization, in accordance with the architecture of an exemplary embodiment of the invention, an effective delineation between the visual components (interface) and the data extraction layers (implementation) is provided by visualization engine 44 receiving notification from query engine 42 and commanding how the user interface response on line 25 should be constructed or appear. In order to glue the interface to the implementation, embedded JSP scripting logic 50 is used to generate the visualizations on the client side 25. This process is two-fold. Once servlet 34 extracts and normalizes the data source 32 into the appropriate XML structure 43, the resulting document node is then dispatched to the receiving JSP 50. Essentially, all of the data packaging is performed before it reaches the client side 25 for visualization. The page is selected by the value parameter of a user HTTP request, which is an identifier for the appropriate JSP file 50. Layout pages 50 receive the result set XML 120 on line 43, and once received an XSL transform takes effect that executes an XSL transformation to produce parameters necessary to launch the visualization.

For a visualization to occur at client 24, a specific set of parameters needs to be passed to the chart applet provided by, for example, Visual Mining's Netcharts solution. XSL transformation 52 generates the necessary Chart Definition Language (CDLs) parameters, a format used to specify data parameters and chart properties. Other visualizations may involve only HTML (for example, as when a table of information is displayed).

Table 3 illustrates an example of CDL defined parameters as generated by XSL transforms 52 and fed to client 24 on line 25 from visualization engine 44.

TABLE 3
CHART DEFINITION LANGUAGE EXAMPLE

| 1 | DebugSet = LICENSE; | |
|---|---|---|
| 2 | Background = (white, NONE, 0); | |
| 3 | Bar3DDepth = 15; | |
| 4 | | |
| 5 | LeftTics = (“ON”, black, “Helvetica”, 11); | |
| 6 | LeftFormat = (INTEGER); | |
| 7 | LeftTitle = (“Recency Level”, x758EC5, helvetica, | |
| 8 | 12, 270); | |
| 9 | | |
| 10 | BottomTics = (“OFF”, black, “Helvetica”, 11, 0); | |
| 11 | | |
| 12 | Grid = (lightgray, white, black), (xCCCCCC, | |
| 13 | null, null); | |
| 14 | GridLine = (HORIZONTAL, DOTTED, 1),(HORIZONTAL, | |
| | SOLID, | |
| 15 | 1); | |
| 16 | GridAxis = (TOP, LEFT), (BOTTOM, LEFT); | |
| 17 | | |
| 18 | GraphLayout | = VERTICAL; |
| 19 | | |
| 20 | Footer | = (“Categories”, x758EC5, helvetica, 12, |
| 21 | 0); | |
| 22 | Header | = (“Category Recency”, black, helvetica, |

| | |
|---|---|
| 23 | 18, 0); |
| 24 | |
| 25 | DwellLabel =(“”, black, “Helvetica”, 10); |
| 26 | DwellBox = (xe3e3e3, SHADOW, 2); |
| 27 | |
| 28 | BarLabels = “Uncategorized Documents”, “Domino.Doc”, |
| 29 | “Portals”, “Industry News and Analysis”, “Cross-product”, |
| 30 | “Technologies”, “Discovery Server”, “Other Products”, |
| 31 | “Domino Workflow”; |
| 32 | |
| 33 | ColorTable = xDDFFDD, xDDFFDD, xDDFFDD, xDDFFDD, |
| 34 | xDDFFDD, xDDFFDD, xDDFFDD, xDDFFDD, xDDFFDD; |
| 35 | DataSets = (“Last Modified Date”); |
| 36 | DataSet1 = 45, 29, 23, 17, 10, 10, 9, 9, 0; |
| 37 | ActiveLabels1 = (“Home>Uncategorized Documents”), |
| 38 | (“Home>Domino.Doc”), (“Home>Portals”), (“Home>Industry News |
| 39 | and Analysis”), (“Home>Cross-product”), |
| 40 | (“Home>Technologies”), (“Home>Discovery Server”), |
| 41 | (“Home>Other Products”), (“Home>Domino Workflow”); |

An XSL stylesheet (or transform) 52 is used to translate the QRML document on line 43 into the specific CDL format shown above on line 25. Table 4 illustrates an example of how an XSL stylesheet 52 defines the translation.

TABLE 4
XSL STYLESHEET TRANSLATION EXAMPLE

| | |
|---|---|
| 1 | <?xml version=“1.0”?> |
| 2 | <xsl:stylesheet |

| | |
|---|---|
| 3 | version=“1.0” |
| 4 | xmlns:xsl=“http://www.w3.org/1999/XSL/Transform” |
| 5 | > |
| 6 | |

| | |
|---|---|
| 7 | <xsl:output method=‘text’ /> |
| 8 | |

| | |
|---|---|
| 9 | <!--Visualization type: bar chart representation--> |
| 10 | <!--Category Lifespan--> |
| 11 | |
| 12 | <xsl:template match=“/”> |

| | |
|---|---|
| 13 | <xsl:apply-templates /> |

| | |
|---|---|
| 14 | </xsl:template> |
| 15 | <xsl:template match=“datasets”> |

| 16 | DebugSet = LICENSE; | |
|---|---|---|
| 17 | Background | = (white, NONE, 0); |

| 18 | Bar3DDepth = 15; | |
|---|---|---|
| 19 | | |
| 20 | LeftTics | = (“ON”, black, “Helvetica”, 11); |

| | | |
|---|---|---|
| 21 | LeftFormat | = (INTEGER); |

| | | |
|---|---|---|
| 22 | LeftTitle | = (“Recency Level”, x758EC5, helvetica, |

| | |
|---|---|
| 23 | 12, 270); |
| 24 | |

| | |
|---|---|
| 25 | BottomTics = (“OFF”, black, “Helvetica”, 11, 0); |

26

| | | |
|---|---|---|
| 27 | Grid | = (lightgray, white, black), (xCCCCCC, |

| | |
|---|---|
| 28 | null, null); |

| | |
|---|---|
| 29 | GridLine = (HORIZONTAL, DOTTED, 1), (HORIZONTAL, SOLID, |

| | |
|---|---|
| 30 | 1); |

| 31 | GridAxis = (TOP, LEFT), (BOTTOM, LEFT); | |
|---|---|---|
| 32 | | |
| 33 | GraphLayout = VERTICAL; | |
| 34 | | |
| 35 | Footer | = (“Categories”, x758EC5, helvetica, 12, |

| | |
|---|---|
| 36 | 0); |

| | | |
|---|---|---|
| 37 | Header | = (“Category Recency”, black, helvetica, |

| | |
|---|---|
| 38 | 18, 0); |
| 39 | |

| | | |
|---|---|---|
| 40 | DwellLabel | = (“”, black, “Helvetica”, 10); |

| | |
|---|---|
| 41 | DwellBox = (xe3e3e3, SHADOW, 2); |

| | |
|---|---|
| 42 | <xsl:apply-templates /> |
| 43 | </xsl:template> |
| 44 | |
| 45 | <xsl:template match=“dataset”> |

| | |
|---|---|
| 46 | BarLabels = <xsl:for-each select=“member”>“<xsl:value- |

| | |
|---|---|
| 47 | of select=”elem[3]“/>”<xsl:if |
| 48 | test=“not(position( )=last( ))”>, </xsl:if></xsl:for-each>; |
| 49 | |

| | |
|---|---|
| 50 | ColorTable = <xsl:for-each |

| | |
|---|---|
| 51 | select=“member”>xDDFFDD<xsl:if |
| 52 | test=“not(position( )=last( ))”>, </xsl:if></xsl:for-each>; |

| | |
|---|---|
| 53 | DataSets = (“Last Modified Date”); |
| 54 | <xsl:variable name=“count” select=“1”/> |
| 55 | DataSet<xsl:value-of select=“$count”/> = <xsl:for-each |

| | |
|---|---|
| 56 | select=“member”><xsl:value-of select=“elem[1]”/><xsl:if |
| 57 | test=“not(position( )=last( ))”>, </xsl:if></xsl:for-each>; |

| | |
|---|---|
| 58 | ActiveLabels<xsl:value-of select=“$count”/> = |

| | |
|---|---|
| 59 | <xsl:for-each select=“member”>(“<xsl:value-of |
| 60 | select=”elem[2]“/>”)<xsl:if test=“not(position( )=last( ))”>, |
| 61 | </xsl:if></xsl:for-each>; |

| | |
|---|---|
| 62 | </xsl:template> |
| 63 | |

| | |
|---|---|
| 64 | </xsl:stylesheet> |
| 65 | |

This process of data retrieval, binding, and translation all occur within a JSP page 50. An XSLTBean opens an XSL file 52 and applies it to the XML 43 that represents the results of the SQL query. (This XML is retrieved by calling queryResp.getDocumentElement( )). The final result of executing this JSP 50 is that a HTML page 25 is sent to browser 24. This HTML page will include, if necessary, a tag that runs a charting applet (and provides that applet with the parameters and data it needs to display correctly). In simple cases, the HTML page includes only HTML tags (for example, as in the case where a simple table is displayed at browser 24). This use of XSL and XML within a JSP is a well-known Java development practice.

TABLE 5
VISUALIZATION PARAMETERS GENERATION EXAMPLE

| | |
|---|---|
| 1 | <%@ page language=“java” autoFlush=“false” |
| 2 | import=“com.ibm.raven.*, com.ibm.raven.applets.beans.*, |
| 3 | org.w3c.dom.*, javax.xml.*, javax.xml.transform.stream.*, |
| 4 | javax.xml.transform.dom.*, java.io.*, javax.xml.transform.*” |
| 5 | buffer=“500 kb”%> |
| 6 | <% |
| 7 | //retrieve the pre-packaged bean dispatched from |
| 8 | ExtremeVisualizer servlet |
| 9 | Document queryResp = (Document) |
| 10 | request.getAttribute(“visualization”); |
| 11 | |
| 12 | //retrieve parameters dispatched from the servlet |
| 13 | String queryAlias = request.getParameter(“queryAlias”); |
| 14 | |
| 15 | String fullyQualified = |
| 16 | request.getParameter(“fullyQualified”); |
| 17 | |
| 18 | //query to use |
| 19 | String query; |
| 20 | %> |
| 21 | <APPLET NAME=barchart |
| 22 | CODEBASE=/Netcharts/classes |
| 23 | ARCHIVE=netcharts.jar |
| 24 | CODE=NFBarchartApp.class |
| 25 | WIDTH=420 HEIGHT=350> |
| 26 | |
| 27 | <PARAM NAME=NFParamScript VALUE = ’ |
| 28 | <% |
| 29 | try |
| 30 | { |
| 31 | query = (fullyQualified != null) ? queryAlias + |
| 32 | “_flat” : queryAlias; |
| 33 | XSLTBean xslt = new |
| 34 | XSLTBean(getServletContext( ).getRealPath(“/visualizations/xsl/ |
| 35 | visualization_” + query + “.xsl”)); |
| 36 | |
| 37 | xslt.translate( new |
| 38 | javax.xml.transform.dom.DOMSource(queryResp. |
| | getDocumentElement |
| 39 | ( )), |
| 40 | new javax.xml.transform.stream.StreamResult(out)); |
| 41 | |
| 42 | } |
| 43 | catch(Exception e) |
| 44 | { |
| 45 | out.println(“XSL Processing Error”); |
| 46 | e.printStackTrace(out); |
| 47 | } |
| 48 | |
| 49 | %> |
| 50 | ‘> |
| 51 | </applet> |

Table 6 is an example SQL query as issued by Servlet 34.

TABLE 6
Example SQL Query

| | |
|---|---|
| 1 | select doctitle, decimal(M.value,16,4) \ |
| 2 | from lotusrds.metrics M \ |
| 3 | join lotusrds.registry R on (R.metricid = M.metricid and |
| 4 | R.metricname = ‘DOCVALUE’) \ |
| 5 | join lotusrds.entity E3 on (E3.entityaliasid = M.entityid1 |
| 6 | and E3.entityaclass=1) \ |
| 7 | join lotusrds.docmeta D on D.docid = E3.entityname \ |
| 8 | join lotusrds.cluster_docs CD on CD.docid = D.docid \ |
| 9 | join lotusrds.entity E1 on E1.entityname = CD.clid \ |
| 10 | join lotusrds.entity E2 on E2.entityid = E1.entityaliasid \ |
| 11 | where E2.entityname like ‘Home>Discovery Server>Spiders%’ \ |
| 12 | order by docmetricvalue DESC, doctitle |

This example returns the titles of documents that are contained by the category “Home-> Discovery Server->Spiders”, as well as in any subcategories of “Spiders”. The query results are sorted by document value, from highest to lowest value. The name of the category (“Home->Discovery Server->Spiders” in the example) is taken from a parameter in Request Header 40 by Servlet 34, and then used by Servlet 34 in constructing dynamic SQL queries 22. Referring to FIG. 4, the category name is an example of a <defineparameter> element 114.

The example query draws on data contained in a number of database tables that are maintained by the Discovery Server. The METRICS table is where all of the metrics are stored, and this query is interested in only the DOCVALUE metric. The REGISTRY table defines the types of metrics that are collected, and is used here to filter out all metrics except the DOCVALUE metric. Records in the METRICS table use identifiers rather than document titles to identify documents. Since the example query outputs document titles, it is necessary to convert document ids to titles. The document titles are stored in the DOCMETA table, and so the document title is extracted by joining the METRICS table to the ENTITY table (to get the document id) and then doing an additional join to DOCMETA (to get the document title).

In order to select documents that belong to a particular category, the categories to which the document belongs also need to be obtained. This information is stored in the CLUSTER_DOCS table, and so the join to CLUSTER_DOCS makes category ids available. These category ids are transformed to category names through additional joins to the ENTITY table.

An exemplary embodiment of the system and method of the invention may be built using the Java programming language on the Jakarta Tomcat platform (v3.2.3) using the Model-View-Controller (MVC) (also known as Model 2) architecture to separate the data model from the view mechanism.

### Information Aggregate

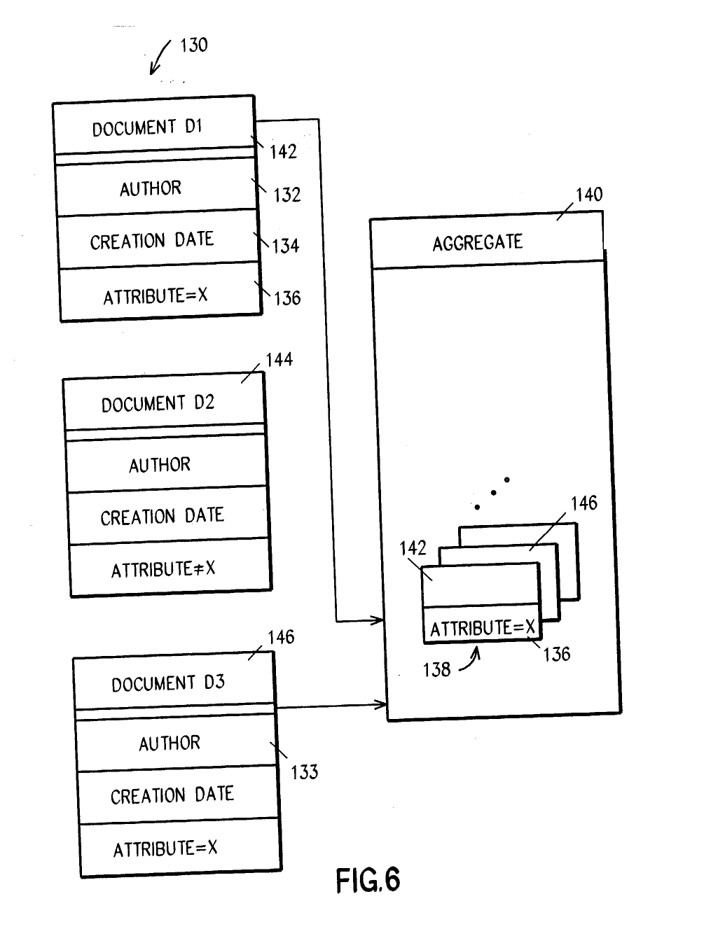

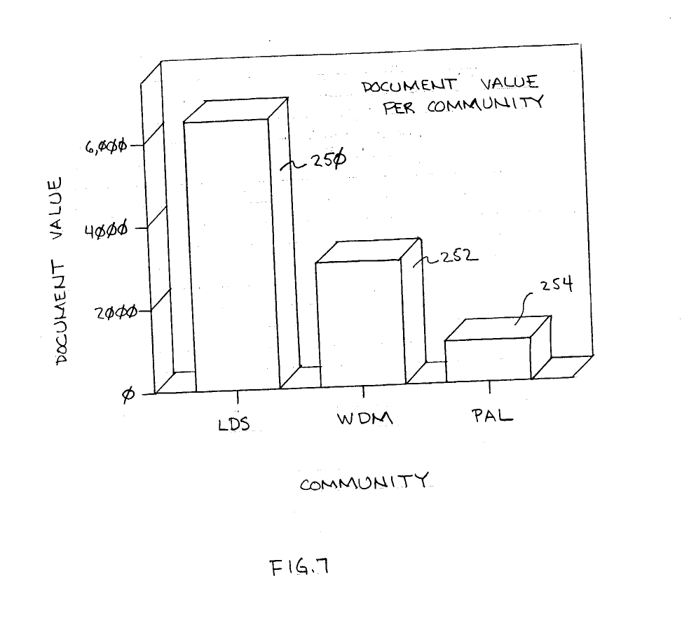

Referring to FIG. 6, a system in accordance with the present invention contains documents 130 such as Web pages, records in Notes databases, and e-mails. Each document can be assigned a value that represents its usefulness. These document values are calculated by the system based on user activity or assigned by readers of the documents. Each document 130 is associated with its author 132, and the date of its creation 134. A collection of selected documents 130 forms an aggregate 140. An aggregate 140 is a collection 138 of documents 142, 146 having a shared attribute 136 having non-unique values.

Given an aggregate, the knowledge capital associated with the aggregate is calculated by summing the usefulness values assigned to each document within the aggregate. This knowledge capital for an aggregate may be normalized by dividing the sum of usefulness values by the number of documents.

Documents 138 can be aggregated by attributes 136 such as:

Category—a collection of documents 130 about a specific topic.

Community—a collection of documents 130 of interest to a given group of people.

Location—a collection of documents 130 authored by people in a geographic location (e.g. USA, Utah, Massachusetts, Europe).

Job function or role—a collection of documents 130 authored by people in particular job roles (e.g. Marketing, Development).

Group (where group is a list of people)— a collection of documents authored by a given set of people.

Person—a collection of documents that have been created by a specified person.

Any other attributed 136 shared by a group (and having non-unique values).

Changes in the knowledge capital of an aggregate can be tracked over time by periodically capturing and storing the total value of the aggregate. Changes in time can then be plotted in a graph to reveal trends.

### Knowledge Capital

In accordance with the preferred embodiment of the system and method of the invention, a knowledge capital metric helps people locate interesting sources of information by looking at the valuation of information aggregates. The main advantage of the knowledge capital metric is that it can improve organizational effectiveness. If people can identify interesting and useful sources of information more quickly, then they can be more effective in getting their jobs done. Higher effectiveness translates into higher productivity.

A knowledge capital metric can also assist managers in identifying high-performance teams. For example, if a particular geographic area consistently generates large amounts of knowledge capital, then this geography might be using best practices that should be adopted by other geographies.

Referring to FIG. 9, in accordance with the preferred embodiment of the invention, a system is provided containing documents, each of which can be assigned a value in step 362 that represents its usefulness. The document values can calculated by the system based on user activity or assigned manually by readers of the document. In step 360, documents are collected together into aggregates. One example of an aggregate might be a category which could group together documents that concern a particular topic.

Knowledge capital is a measure of how much value has been created within an information aggregate during a specified period of time. In a preferred embodiment, documents are aggregated into communities, and the knowledge capital generated by each community is calculated by summing the values assigned the documents in the community.

To determine the value of knowledge capital, in step 364 usefulness values for all of the documents included within the aggregate (step 360) are summed (Vt). In step 366 the sum of values for the documents of the aggregate are optionally normalized by dividing that sum by the number of document (N) in the aggregate. In step 368 the knowledge capital for this aggregate is optionally repeated in successive time periods.

Steps 360-368 may be repeated for each of a plurality of aggregates.

In steps 370, 372, the knowledge capital (optionally normalized, and optionally computed in successive time periods) may be displayed for categories and for communities in, for example, bar charts.

The knowledge capital metric is different from collaborative filtering because it focuses on collections of documents, rather than individual documents. Using a collection to generate metrics can provide more context to to people who are looking for information.

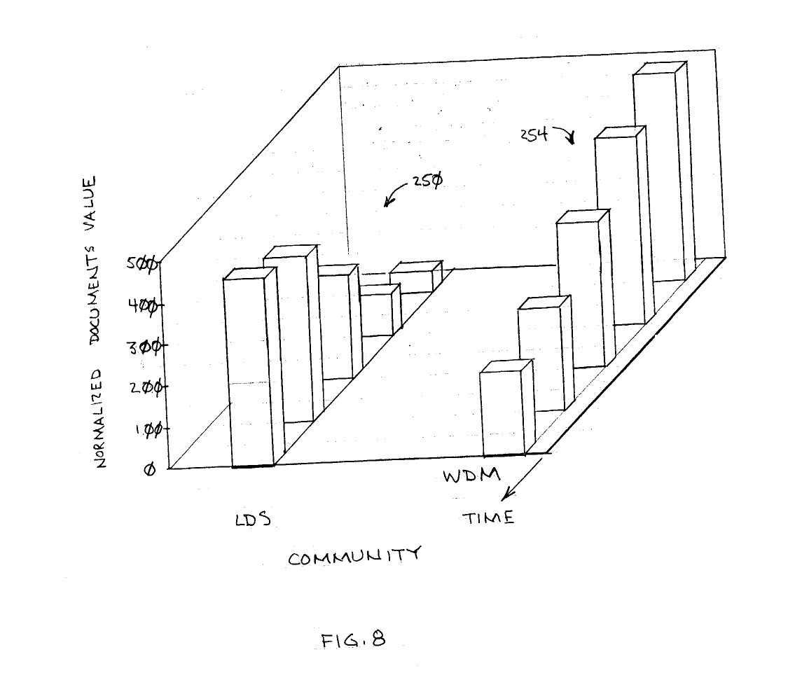

FIG. 7 shows the knowledge metrics for a set of communities LDS 250, WDM 252 and PAL 254, visualized per step 372 of FIG. 9. This example illustrates that the Lotus Discover Server (LDS) community 250 has generated more value than the workflow and data management (WDM) and Portals at Lotus (PAL) communities. LDS is therefore an area where there is currently high value corporate activity.

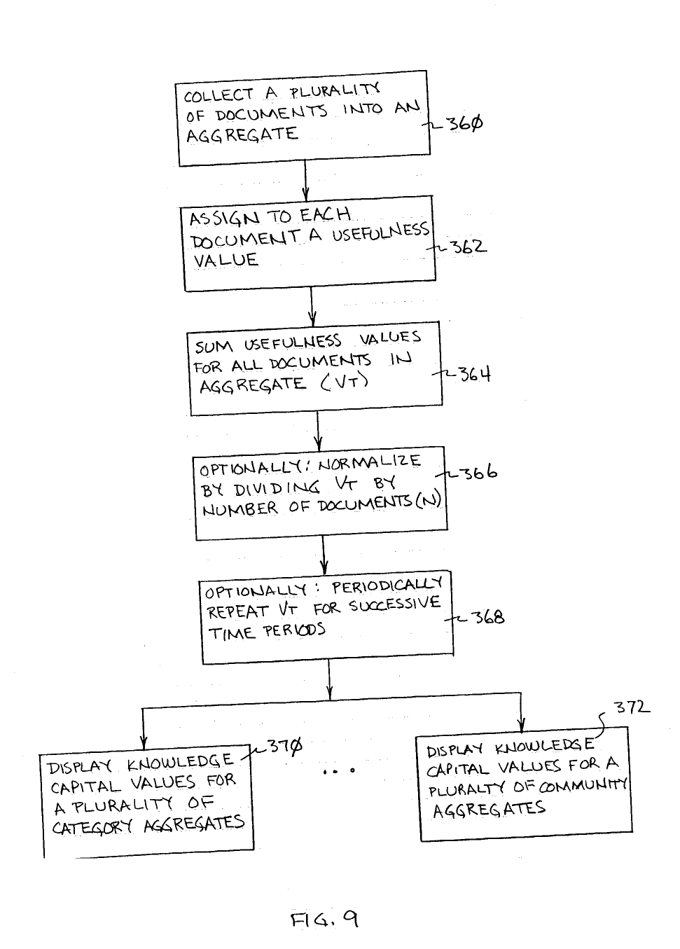

FIG. 8 shows the knowledge capital metrics for the LDS 250 and WDM 254 communities normalized and tracked with respect to time, again visualized per step 372 of FIG. 9. This example illustrates that, over time, the normalized value of knowledge capital of the LDS community 250 is growing, and that for the WDM community 254 is declining.

In accordance with an exemplary embodiment of the invention, graphic representations of knowledge capital, such as are illustrated in FIGS. 7 and 8, are presented on a company's Intranet page where employees can easily see where value is being generated, and investigate further if they have a particular interest in the practices of a visualized category, community, location, job function or role, group, person, or any other aggregate.

### Advantages over the Prior Art

It is an advantage of the invention that there is provided an improved system and method for determining and visualizing knowledge capital generated within a knowledge repository.

### Alternative Embodiments

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure its components in accordance with the system of the invention.

Further, each step of the method may be executed on any general computer, such as IBM Systems designated as zSeries, iSeries, xSeries, and pSeries, or the like and pursuant to one or more, or a part of one or more, program elements, modules or objects generated from any programming language, such as C++, Java, Pl/1, Fortran or the like. And still further, each said step, or a file or object or the like implementing each said step, may be executed by special purpose hardware or a circuit module designed for that purpose.

Accordingly, the scope of protection of this invention is limited only by the following claims and their equivalents.

We claim:

1. A method for evaluating information aggregates, comprising:
collecting a plurality of documents having non-unique values on a shared attribute into an information aggregate;
assigning to each said document an usefulness value; and
calculating and visualizing the knowledge capital of said aggregate as the sum of said usefulness values for all said documents.

2. The method of claim 1, further comprising normalizing said knowledge capital by dividing said sum by the number of said documents.

3. The method of claim 1, further comprising tracking changes to said knowledge capital over time.

4. The method of claim 1, further comprising:
visualizing said knowledge capital for a plurality of categories.

5. The method of claim 1, further comprising:
visualizing said knowledge capital for a plurality of communities.

6. The method of claim 1, further comprising:
visualizing said knowledge capital for a plurality of geographies.

7. The method of claim 1, further comprising:
visualizing said knowledge capital for a plurality of job roles.

8. The method of claim 1, further comprising:
visualizing said knowledge capital for a person or group of people.

9. System for evaluating an information aggregate, comprising:
means for collecting a plurality of documents having non-unique values on a shared attribute into an information aggregate; and
means for identifying and visualizing aggregate knowledge capital for a plurality of categories, communities, job roles, geographies, and people.

10. The system of claim 9, further comprising:
means for tracking changes to said knowledge capital of over time.

11. System for evaluating an information aggregate, comprising:
a metrics database for storing document indicia including document attributes, associated persons and assigned usefulness value;
a query engine responsive to a user request and said metrics database for aggregating documents having same, unique attributes in an information aggregate;
said query engine further for calculating aggregate knowledge capital values as the sum of said usefulness values of all documents in said information aggregate; and
a visualization engine for visualizing said knowledge capital values at a client display.

12. The system of claim 11, said visualization engine visualizing said knowledge capital values for a plurality of communities.

13. The system of claim 11, said visualization engine visualizing said knowledge capital values for a plurality of categories.

14. The system of claim 11, said query engine further for normalizing said knowledge capital values by dividing said sum by the number of documents in said information aggregate.

15. The system of claim 11, said visualization engine further for tracking changes to said knowledge capital over time.

16. A program storage device readable by a machine, tangibly embodying a program of instructions executable by a machine to a perform method for evaluating information aggregates, said method comprising:
collecting a plurality of documents having non-unique values on a shared attribute into an information aggregate;
assigning to each said document an usefulness value; and
calculating and visualizing knowledge capital of said aggregate as a sum of said usefulness values for all said documents.

17. The program storage device of claim 16, said method further comprising:
visualizing said knowledge capital for a plurality of categories.

18. The program storage device of claim 16, said method further comprising:
visualizing said knowledge capital for a plurality of communities.

19. The program storage device of claim 16, said method further comprising:
visualizing said knowledge capital for plurality of job roles.

20. The program storage device of claim 16, said method further comprising:
visualizing said knowledge capital for a person or group of people.

21. The program storage device of claim 16, said method further comprising:
visualizing said knowledge capital for a plurality of geographies.

22. The program storage device of claim 16, said method further comprising:
tracking and visualizing changes to said knowledge capital over time.

23. A program storage device readable by a machine, tangibly embodying a program of instructions executable by a machine to a perform method for evaluating information aggregates, said method comprising:
storing document indicia in a metrics database, said indicia including document attributes, associated persons and assigned usefulness value;
responsive to a user request and said metrics database, aggregating documents having same, unique attributes in an information aggregate;
calculating aggregate knowledge capital values as the sum of said usefulness values of all documents in said information aggregate; and
visualizing said knowledge capital values selectively for a plurality of categories, plurality of geographies, a person or group of people, a plurality of geographies, a person or group of people, a plurality of job roles, or a plurality of communities at a client display.

24. A computer program product for evaluating information aggregates according to the method comprising:
storing document indicia in a metrics database, said indicia including document attributes, associated persons and assigned usefulness value;
responsive to a user request and said metrics database, aggregating documents having same, unique attributes in an information aggregate;
calculating aggregate knowledge capital values as the sum of said usefulness values of all documents in said information aggregate; and
visualizing said knowledge capital values selectively for a plurality of categories, plurality of geographies, a person or group of people, a plurality of geographies, a person or group of people, a plurality of job roles, or a plurality of communities at a client display.
